(19) United States
(12) Patent Application Publication
(10) Pub. No.: US 2025/0170596 A1
(43) Pub. Date: May 29, 2025

(54) LINER DISCHARGE STRUCTURE WITH RIBS

(71) Applicant: Freedom Manufacturing LLC, Saratoga Springs, NY (US)

(72) Inventor: Jon G. Lawrence, Porter Corners, NY (US)

(21) Appl. No.: 18/961,613

(22) Filed: Nov. 27, 2024

Related U.S. Application Data
(60) Provisional application No. 63/602,779, filed on Nov. 27, 2023.

(51) Int. Cl. B05B 1/22

(52) U.S. Cl. CPC B05B 1/22

(57) ABSTRACT

Embodiments of the disclosure provide a liner discharge structure adapted for insertion within a discharge spout of a container. The liner discharge structure includes a liner passage including a liner material and enclosing a cross-sectional area substantially equal to a cross-sectional area of the discharge spout. The liner discharge structure further includes a rib structure including a plurality of ribs extending at least partially along an extent of the liner passage between the first end and the second end. The liner discharge structure further includes a base at the first end of the liner material, and a flange circumferentially coupled to the second end of the liner.

### TECHNICAL FIELD

The present disclosure relates to liners for industrial bulk containers. More specifically, embodiments of the disclosure provide various embodiments of a liner discharge structure.

### BACKGROUND ART

Hard or flexible discharge spouts have historically been made from injected molded parts, which are often made of materials different than from that which the liner is constructed. Chemical compatibility of the liner with contents is always a concern, and adding additional materials to construct liner discharge spouts adds additional problems regarding chemical compatibility and ability seal dissimilar materials to create the liner.

Another problem specific to tubular shape discharge spouts is that such spouts must be shaped to fit through the tank discharge piping. Certain difficulties arise from the flange at the end of the discharge spout being larger than the inside diameter of the tank discharge piping. The flange, in this case, sits flat against the quick-disconnect surface to seal the liner and tank against leakage. Consequently, the larger the outside diameter of the liner discharge spout, the less clearance is available to move this flange through the tank discharge piping. The smaller the outside diameter of the liner discharge spout, the more restricted the product flow during emptying of the tank. Pumping the contents of the container creates a low-pressure area in the discharge piping. This low-pressure area, in some cases, may render the discharge spout of the liner susceptible to collapses which restrict or prevent discharge of the tank. Thus, additional components are necessary to install the liner because the discharge spouts have to be guided through the tank discharge piping and openings. Maintaining a tight fit requires operators to insert equipment into the tank from the discharge opening and retrieve the discharge spouts of the liner and pull it through.

The discharge spout of a liner also interfaces with any valves in piping, e.g., butterfly, gate, and ball valves that are currently installed on the intermediate bulk container (“IBC”). To apply a liner, the discharge spoke and valves on the container must be modified slightly, e.g., by removing the ball valves and reattaching it to the piping using some form of quick disconnect connection. The discharge spout on the liner can then move through and be installed in the discharge pipe right up to the quick disconnect connection. The ball valves can then be reattached to the tank. This procedure seals the discharge of the liner, preventing any leakage back into the IBC or out of the IBC. Problems may arise in cases where the discharge spout has a small inside diameter restricting the flow rate of the material leaving the tank. Additionally, these spouts have been made of material or materials which is/are dissimilar to the liner material. This creates an additional challenge of meeting chemical compatibility issues with the liner.

### SUMMARY

The illustrative aspects of the present disclosure are designed to solve the problems herein described and/or other problems not discussed.

An aspect of this disclosure a liner discharge structure adapted for insertion within a discharge spout of a container, the liner discharge structure comprising: a liner passage including a liner material and enclosing a cross-sectional area substantially equal to a cross-sectional area of the discharge spout, the liner passage including a first end opposite a second end; a rib structure including a plurality of ribs extending at least partially along an extent of the liner passage between the first end and the second end; a base at the first end of the liner passage; and a flange circumferentially coupled to the second end of the liner passage.

Another aspect of this disclosure provides where the rib structure is collapsible.

Another aspect of this disclosure provides where the liner passage is flexible and wherein at least one rib in the plurality of ribs is rigid.

Another aspect of this disclosure provides where the plurality of ribs includes a plurality of substantially uniformly spaced ribs.

Another aspect of this disclosure provides where at least one rib in the plurality of ribs includes a substantially triangular cross-sectional profile.

Another aspect of this disclosure provides where each rib in the plurality of ribs are connected by a connecting member extending at least partially along a longitudinal extent of the liner passage.

Another aspect of this disclosure provides where a first rib in the plurality of ribs includes a first length greater than a second length of a second rib in the plurality of ribs.

Another aspect of this disclosure provides where the liner passage includes a rigid portion laterally adjacent at least one end of the connecting member.

Another aspect of this disclosure provides where a cross-sectional area of the flange is greater than a cross-sectional area of the discharge spout.

Another aspect of this disclosure provides where the flange includes a substantially circular profile.

Another aspect of this disclosure provides where a diameter of the flange is greater than a diameter of the discharge spout.

Another aspect of this disclosure provides where the plurality of ribs extend at least partially along a longitudinal extent of the liner passage and intersect with each other.

An aspect of this disclosure a liner discharge structure adapted for insertion within a discharge spout of a container, the liner discharge structure comprising: a liner passage including a liner material and enclosing a cross-sectional area substantially equal to a cross-sectional area of the discharge spout, the liner passage including a first end opposite a second end, wherein the liner material is flexible; a rib structure including a plurality of ribs extending at least partially along an extent of the liner passage between the first end and the second end, wherein the rib structure is collapsable and wherein at least one rib in the plurality of ribs is rigid; a base at the first end of the liner passage; and a flange circumferentially coupled to the second end of the liner passage.

Another aspect of this disclosure provides where at least one rib in the plurality of ribs includes a substantially triangular cross-sectional profile.

Another aspect of this disclosure provides where the plurality of ribs includes substantially uniformly spaced ribs.

Another aspect of this disclosure provides where a first rib in the plurality of ribs includes a first length greater than a second length of a second rib in the plurality of ribs.

Another aspect of this disclosure provides a method to install a liner discharge structure within a discharge spout of a container, the method comprising: passing a liner discharge structure through the discharge spout, wherein the liner discharge structure includes: a liner passage having a liner material and enclosing a cross-sectional area substantially equal to a cross-sectional area of the discharge spout, the liner passage having a first end opposite a second end, and a rib structure including a plurality of ribs extending at least partially along an extent of the liner passage between the first end and the second end; mounting a base coupled to the first end of the liner passage on a first end of the discharge spout; and mounting a flange coupled to the second end of the liner passage on the second end of the discharge spout.

Another aspect of this disclosure provides circumferentially constricting a portion of the rib structure with a fastener during the passing of the liner discharge structure through the discharge spout; and releasing the fastener from the rib structure after mounting the base and the flange on the discharge.

Another aspect of this disclosure provides where the plurality of ribs includes substantially uniformly spaced ribs.

Another aspect of this disclosure provides where a first rib in the plurality of ribs includes a first length greater than a second length of a second rib in the plurality of ribs.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 shows a schematic diagram of a container and a portion of a liner therein, according to embodiments of the disclosure.

FIG. 2 shows a side view of a liner discharge structure with a rib structure with substantially uniform spacing between ribs, according to embodiments of the disclosure.

FIG. 3 shows a side view of a liner discharge structure with a rib structure with triangular ribs, according to embodiments of the disclosure.

FIG. 4 shows a side view of a liner discharge structure with a rib structure with a connecting member, according to embodiments of the disclosure.

FIG. 5 shows a side view of a liner discharge structure with a rib structure with unequal spacing between ribs, according to embodiments of the disclosure.

FIG. 6 shows a side view of a liner discharge structure with a rib structure in an expandable configuration, according to embodiments of the disclosure.

FIG. 7 shows a cross-sectional view of a constricted rib structure within a discharge spout according to embodiments of the disclosure.

FIG. 8 shows a cut away perspective view of a rib structure within a discharge spout according to embodiments of the disclosure.

### DETAILED DESCRIPTION

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

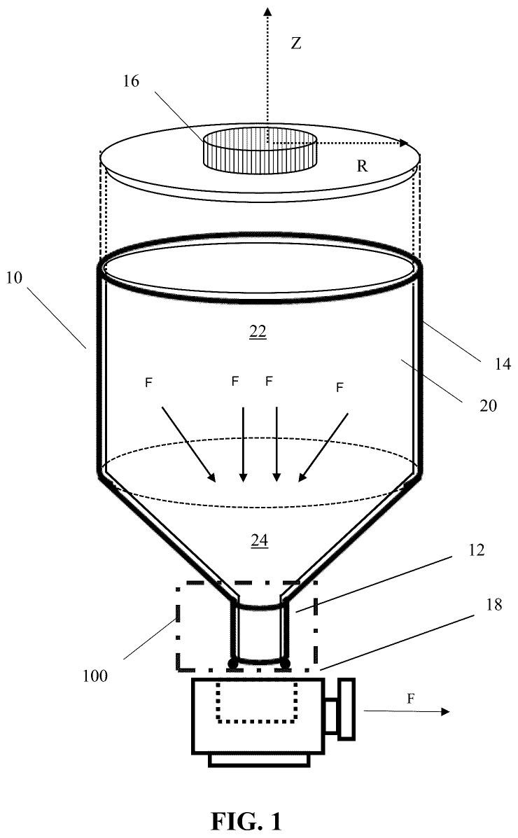

Referring to FIGS. 1-6, a liner discharge structure 100 according to the disclosure may be adapted for insertion within a discharge spout 12 of a container 10. Liner discharge structure 100 may include a discharge spout 12 shaped for use within container 10 (FIG. 1), e.g., an intermediate bulk container (“IBC”) for containing chemicals. Generally, while draining the contents of container 10 through discharge spout 12, a low-pressure area forms within discharge spout 12 and liner discharge structure 100. However, liner discharge structure 100, and its components including liner material 112 and rib structure 110 maintain a desired diameter size of the drain without liner deformation so that product can flow without obstructions and as quickly as possible.

Referring to FIG. 1, an illustrative container 10 generally includes an inner wall 14, a filling port 16 and a discharge spout 12. Container 10 can be of any size, and more specifically can be provided with any conceivable height and/or length dimension as indicated with partial dashed lines. For the purposes of this disclosure, the term container may refer to any tank, tote, vessel, etc., for storing fluids. Further, such containers may be fabricated from any material, including PVC, metal, composites, etc. Discharge spout 12 can receive a valve 18, e.g., with threading, for controlling an amount of fluid discharge from container 10. Container 10 can be positioned within an external structure (not shown) such as a frame, fixture, etc., for maintaining a desired position and/or orientation of container 10 and components thereof during use. Container 10 is illustrated by example as having a vertically-oriented discharge passage (i.e., discharge spout 12 discussed herein), but it is understood that horizontal and diagonally oriented discharge spouts may be used in other embodiments of container 10. Moreover, container 10 itself may have a variety of geometrical profiles, e.g., spherical, cubic, rectangular, conic, and/or any conceivable shape in three dimensions. Such attributes of container 10 may depend, in part, on its intended contents based on various technical considerations not discussed herein.

As shown, container 10 can include liner structure 20 therein having liner body 22, a narrowing region 24, and a liner discharge structure 100 (shown in dashed lines), such that a portion of liner structure 20 is seated at least within discharge spout 12. Container 10 and liner structure 20 can extend substantially along an axial axis “Z,” with a radial axis “R” extending outwardly therefrom. Liner body 22 can be shaped and adapted to conform to inner wall 14 during operation, e.g., by being manufactured with substantially the same size, shape, etc., as container 10 where liner structure 20 is used.

The interposition of narrowing region 24 between liner body 22 and liner discharge structure 100 can cause a cross-sectional area of liner structure 20 at liner discharge structure 100 to be less than a cross-sectional area of liner structure 20 within liner body 22 by a predetermined factor, e.g., by an approximately 1:2, 1:4, 1:10 area ratio or by any other desired ratio between areas. Narrowing region 24 can thus have a distinct shape from liner discharge structure 100 and liner body 22, and in an example embodiment, can make up at least a partially frustoconical region of liner structure 20. In any event, the size of liner structure 20 at various positions can vary during manufacture based on the size of container 10 where liner structure 20 is used, as indicated with the corresponding dashed lines. Embodiments of the present disclosure can include features of liner discharge structure 100 at discharge spout 12 to aid, e.g., the discharge flow of chemicals from container 10 while reducing the amount of slipping or other dislocations of liner structure 20 from container 10.

Although liner structure 20 is shown as being separated from inner wall 14, discharge spout 12, etc., in FIG. 1 for clarity of illustration, it is understood that liner structure 20 and components thereof can structurally conform to the dimensions of container 10 using known techniques. For example, where liner structure 20 is composed of a pliable material such as a polymer compound, the various components of liner structure 20 can take up substantially no space, e.g., by having a thickness of less than approximately 1.0 centimeters (cm) and thereby cause substantially no reduction in the capacity of container 10.

Furthermore, because liner discharge structure 100 is fabricated from the same material as the liner body 22 itself, no nonconforming materials are introduced despite any differences in material rigidity. Use of the same material also allows liner discharge structure 100 to be easily attached to the liner body 22 with known techniques. In a typical embodiment, liner material 112 may comprise a multilayer substrate having properties compatible with the fluid to be placed in container 10. Accordingly, selection of liner material 112 may change from application to application. Using the same liner material(s) 112 for liner body 22 and liner discharge structure 100 ensures a homogeneous containment environment.

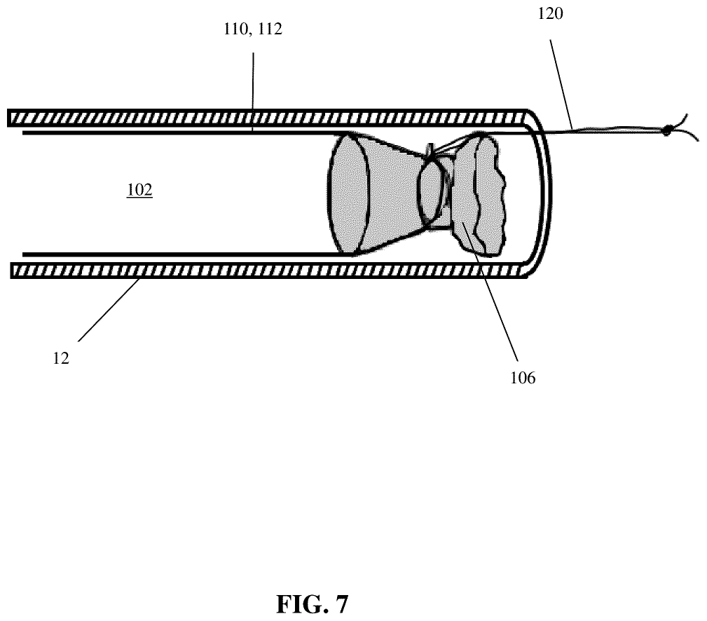

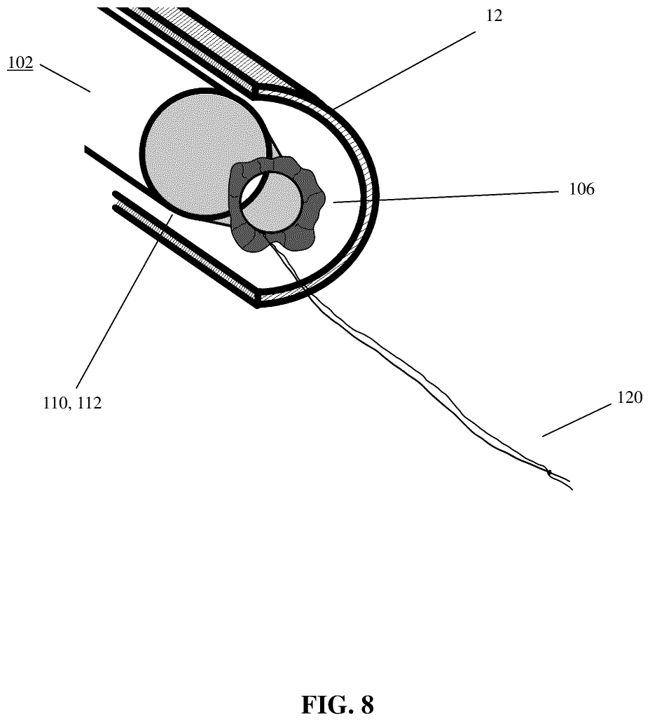

Embodiments of liner discharge structure 100 are configured for applications in which discharge spout 12 is coupled to various types of valves and/or discharge piping for transmitting fluids from within container 10. Related methods of the disclosure may include, e.g., removing one or more valves and/or piping sections, passing liner discharge structure 100 through such piping and/or valves while liner passage 102 is constricted, as shown in FIGS. 7 and 8, and a second end 106 to the exterior of the piping and/or valve(s) using, e.g., a quick disconnect piping connection and/or other connective structure for routing discharged fluid(s).

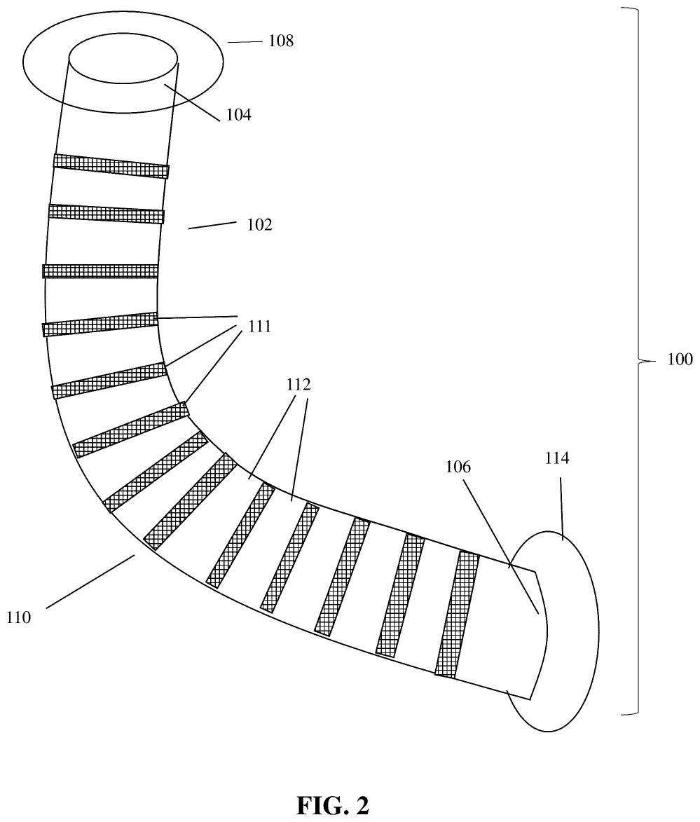

As shown in FIG. 2, liner discharge structure 100 generally may include a liner passage 102, liner material 112, first end 104, second end 106, rib structure 110, base 108, and flange 114. Liner discharge structure 100 according to the disclosure may include a liner passage 102 including a liner material 112 and enclosing a cross-sectional area substantially equal to a cross-sectional area of the discharge spout 12 and including a first end 104 opposite a second end 106. Although liner discharge structure 100 is shown as being separated from discharge spout 12, in FIGS. 2-6 for clarity of illustration, it is understood that liner discharge structure 100 and components thereof can structurally conform to the dimensions of discharge spout 12 using known techniques. For example, where liner discharge structure 100 is composed of a pliable material such as a polymer compound, the various components of liner discharge structure 100 can take up substantially no space, e.g., by having a thickness of less than approximately 1.0 centimeters (cm) and thereby cause substantially no reduction in flow.

Liner material 112 may be for, e.g., safely storing chemicals in container 10 and maybe any known or later developed material and may depend on the contents of container 10. Liner material 112 may be chemically inert relative to any intended contents of container 10 to prevent contamination of such contents and/or degradation of liner material 112. Additionally, Liner passage 102 may be flexible, i.e., the liner passage 102 may deform under pressure or contact. Liner material 112 may include any currently known or later developed material appropriate for use in bulk containers. As an example, liner material 112 may include a polymerous material (e.g., polyethylene) processed into the form of a flexible tube. In further embodiments, liner material 112 can be fabricated, e.g., in a substantial tubular arrangement from one or more sections of liner material that is welded along one or more seams (not shown). Liner material 112, in some implementations, can have a substantially elongated cylindrical shape and flexible composition to provide liner passage 102 between first end 104 and second end 106. Liner material 112 may be interspersed with materials and/or structural features with different compositions to provide desired amounts of rigidity as discussed herein.

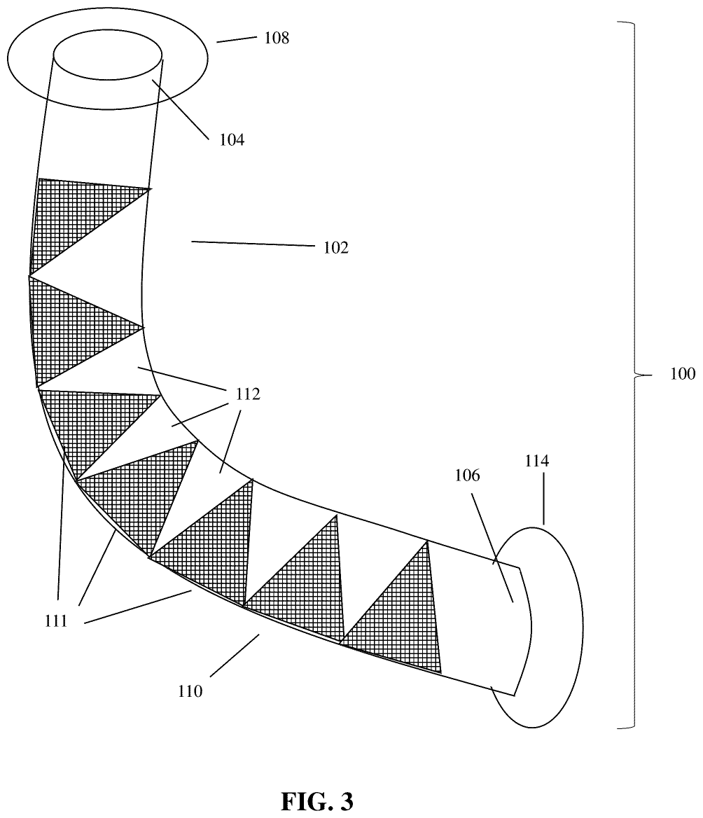

Liner discharge structure 100 may include a rib structure 110 including a plurality of ribs 111 extending at least partially along predetermined lengths of the liner passage 102 within predetermined subsections of liner passage 102 between the first end 104 and the second end 106. In implementations where liner passage 102 may be flexible, at least one rib 111 in the plurality of ribs 111 may be rigid. Rib structure 110 may have the same or similar composition to liner material 112 but may be further processed to create more rigid (and thus less flexible) material properties. In some cases, the surface texture of rib structure 110 may be corrugated i.e., shaped into alternating ridges and grooves. Rib structure 110 may be created from portions of liner material 112 using any technique that does not introduce any foreign material, e.g., heat sealing, vibration welding, ultrasonic welding, etc. Rib structure 110 being provided within liner passage 102 provides areas of greater rigidity than liner material 112 itself. Rib structure 110 thereby helps to prevent the low-pressure region from collapsing the liner material 112 within discharge spout 12. Rib structure 110 may be collapsible i.e. the rib structure 110 may reduce its size in at least one dimension. For example, rib structure 110 may have a portion collapsed so as to reduce the cross-sectional area of liner passage 102 to pass through discharge spout 12. Rib structure 110, due to its composition, may impart an expansive (outward) force from liner material 112 to increase the inside diameter of liner discharge structure 100 within the discharge spout 12, so that product can flow more quickly than possible without rib structure 110. In some embodiments, shown in FIGS. 2 and 3, rib structure 110 may include a plurality of substantially uniformly (or non-uniformly) spaced ribs 111. For example, rib structure 110 may have non-uniformly spaced ribs 111, allowing for liner discharge structure 100 to increase the number of ribs 111 in areas of liner passage 102 that have higher stress/strain during use, while conversely lowering the number of ribs 111 in areas of liner passage 102 with relatively lower amounts of stress/strain.

In a further example shown in FIG. 3, at least one rib 111 of rib structure 110 may include a substantially triangular cross-sectional profile. In this embodiment, the triangular cross-section profile allows liner discharge structure 100 to maintain rigidity around discharge spout's 12 bends of various sizes and bend angles and over a larger surface area than possible with ring-shaped ribs, while reducing the amount of material needed. Rib structure 110 having a triangular cross-section, distributes stress along the length of the rib, reducing concentrations of stress that could lead to failure or deformation in liner passage 102. For example, a discharge spout 12 having a 90-degree bend angle and small radius could have a liner discharge structure 100 with a rib structure includes a plurality of ribs 111 having a substantial triangular cross-sectional profile. In this example, the flexible liner material 112 and plurality of ribs 111 would compress at the portion of liner discharge structure 100 resting in the bend and distributing stress along the plurality of ribs 111 to a larger surface area, allowing the liner discharge structure 100 to maintain rigidity throughout the bend.

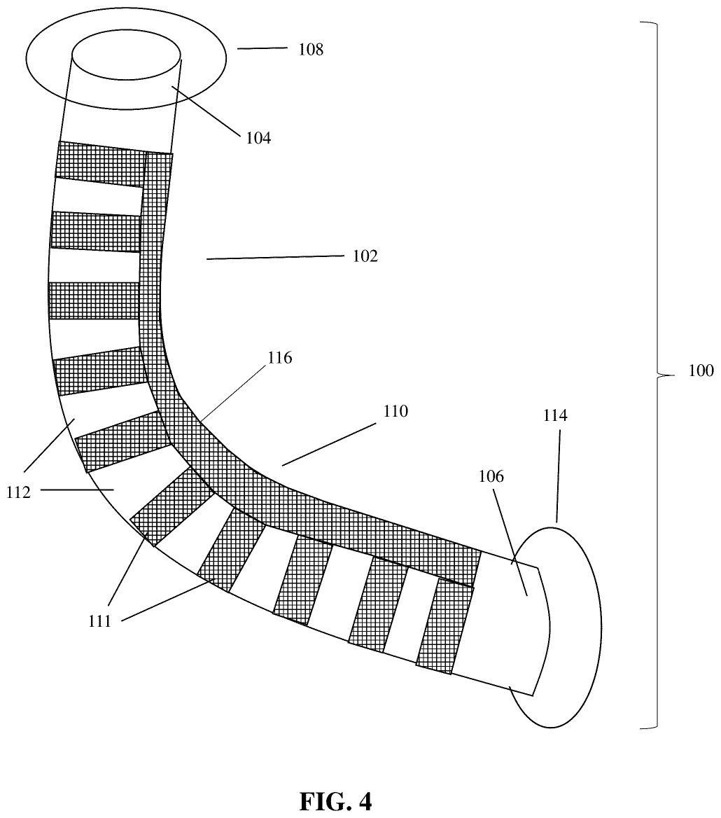

In another example, shown in FIG. 4, each rib 111 in the plurality of ribs 111 may be connected by a connecting member 116 extending at least partially along a longitudinal extent of liner passage 102. Connecting member 116 may be the same or different material than the plurality of ribs 111. Connecting member 116 acts as a longitudinal reinforcement for liner discharge structure 100 that resist twisting and longitudinal compression. Connecting member 116 in combination with plurality of ribs 111 helps ensure that liner discharge structure 100 remains in position and does not deform, by reducing the amount of flexing in liner material 112. For example, while container 10 discharges its contents, a low-pressure region is created in discharge spout 12. In this example, plurality of ribs 111 and connecting member 116 help the cross-sectional area of liner passage 102 to remain substantially equal to the cross-sectional area of the discharge spout.

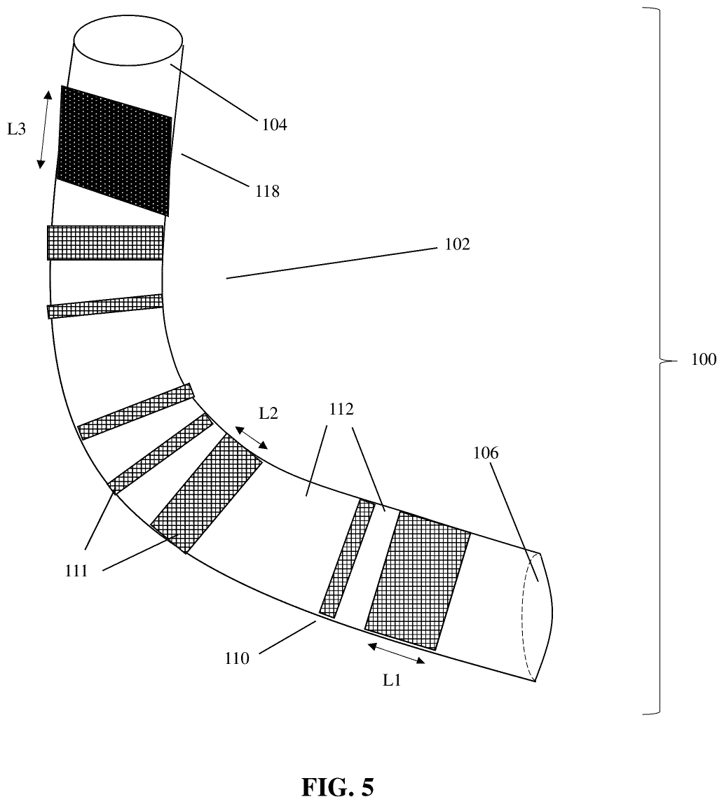

In another example, shown in FIG. 5, a first rib 111 in the plurality of ribs 111 may include a first length L1 may be greater than a second length L2 of a second rib 111 in the plurality of ribs 111. Additionally, shown in FIG. 5, the rib structure 110 may include a rigid portion 118 adjacent either the first end 104 and/or the second end 106. The rigid portion 118 may include a third length L3 and may be greater than L1. In this embodiment, having a plurality of ribs 111 of different lengths allows liner discharge structure 100 to be customizable based on the size and shape of discharge spout 12. In some embodiments the positioning of plurality of ribs 111 with varying lengths may be based on stress/strain applied to the liner discharge structure 100 by the flow of contents from container 10. For example, larger lengths ribs 111 may be positioned in areas of liner discharge structure 100 having high stress/strain, while smaller length ribs 111 may be positioned in areas with lower stress/strain. In some embodiments the positioning of plurality of ribs 111 with varying lengths may be based on a desired flexibility for liner discharge structure 100. For example, discharge spout 12 may be a Z-shaped fitting and the rib structure 110 would in include a plurality of ribs 111 having a smaller length around the bends, to ensure that liner passage does not collapse while still being flexible to fit around the bend. Further, in this example, rib structure 110 may have a plurality of ribs 111 with a greater length in any non-curvilinear portions of discharge spout 12, where flexibility is less of a concern.

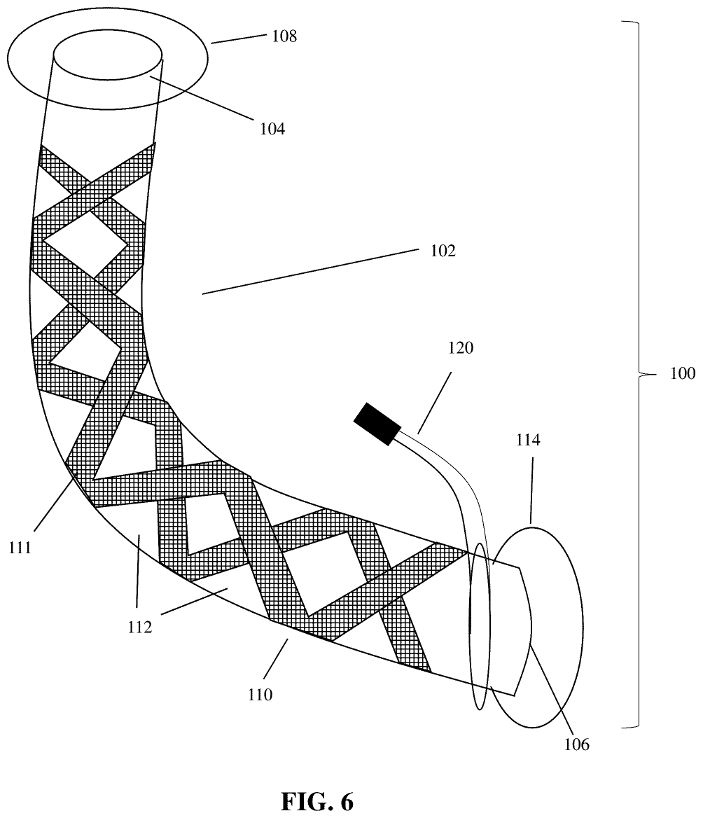

In another embodiment, shown in FIG. 6, ribs 111 may extend partially along a longitudinal extent of the liner passage 102 and intersect with each other, e.g., to define lattice cross pattern structure. In this embodiment, plurality of ribs 111 are able to distribute loads more evenly across liner passage 102, which helps to prevent liner passage 102 from collapsing and unwanted bending or flexing that can reduce flow. Additionally, this embodiment offers rigidity in both the horizontal and vertical direction, protecting liner discharge structure 100 from damage, such as from torsion. For example, rib structure 110 may form a cross pattern on liner passage 102, extending from the first end 104 to second end 106.

The liner discharge structure 100 may include a base 108 at the first end 104 of liner material 112. Base 108 may be, e.g., a flanged member. During use, base 108 may structurally anchor discharge liner structure 100, by any known or later developed method, within an interior of container 10 to maintain a desired diameter and to prevent the liner structure 100 from collapsing, e.g., falling into container 10. In some embodiments, base 108 is circumferentially coupled to liner body 22. Base 108 may have the same or similar composition to rib structure 110 within liner discharge structure 100.

Liner discharge structure 100 may include a flange 114 circumferentially coupled to a second end 106 of liner material 112. In some implementations, a cross-sectional area of flange 114 may be greater than a cross-sectional area of discharge spout 12. In some embodiments the discharge structure is “flanged,” i.e., it is sealed to discharge spout 12 and is greater in diameter than a diameter of discharge spout 12. That is, flange 114 may include a diameter greater than a diameter of discharge spout 12. Flange 114 may include a substantially circular profile, as shown in FIGS. 1-4 and 6. In some embodiments, flange 114 is circumferentially coupled to liner body 22.

An illustrative container 10 including a liner structure 20 with a liner discharge structure 100 is shown in FIG. 1. FIGS. 2-6 show various side views of liner discharge structure 100. Specifically, FIGS. 2, 3, and 6 show side view of liner discharge structures 100 with differently arranged ribs 111; FIG. 4 shows a side view of a liner discharge structure 100 with a connecting member 116; and FIG. 5 shows a side view of a liner discharge structure 100 with different sized ribs 111. Embodiments of liner discharge structure 100 with rib structure 110 therein provide mechanical resistance to any downward forces imparted by fluids, etc., passing through discharge spout 12 through opening of bottom of container 10. Flange 114 may be advantageously located at the end of the drain and may be used to seal liner passage 102 to discharge spout 12 and prevent tank leakage. In another embodiment, liner discharge structure 100 passes through discharge spout 12 and as liner discharge structure 100 approaches an end of discharge spout 12, a sidewall of liner passage 102 is constricted such that flange 114, circumferentially coupled to the second end 106 of liner passage 102, encloses a cross-sectional area that is less than the cross-sectional area of discharge spout 12. Further, flange 114 may pass through an end of discharge spout 12 and the sidewall of liner discharge structure 100 is released, expanding flange 114 has a diameter greater than a diameter of discharge spout 12. A fastener 120 (e.g., a clip formed of deformable materials such as metals, ceramics, etc., a string, a slip, and/or other fastening instruments) may be circumferentially coupled to liner passage 102, e.g., to aid a user in temporarily constricting and expanding liner passage 102. Fastener 120 may include materials such as sealing adhesive (e.g., polytetrafluoroethylene (PTFE)) metal(s), ceramic(s), liner material 112, and/or other currently known or later developed substances.

FIGS. 7 and 8 depict examples of methods of passing liner discharge structure 100 through portions of discharge spout 12 according to embodiments of the disclosure. Such processes may be aided in part by various tools discussed herein including, e.g., rods for guiding liner discharge structure 100 through discharge spout 12, and/or fastener 120 for reducing the cross-sectional area of rib structure 110. Additional components may be used to install liner body 22 according to conventional techniques before guiding liner discharge structure 100 through discharge passage 12. With liner body 22 positioned inside container 10, fastener 120 can reduce the cross-sectional area of liner discharge structure 100 (e.g., collapsing rib structure 110). Liner passage 102 then can be guided through discharge spout 12.

When liner passage 102 reaches a desired location (e.g., second end 106 passing through a second end of discharge spout 12), fastener 120 can be loosened (e.g., by being removed, untied, etc.) to expand rib structure 110. This process allows maintaining of the tight fit between liner discharge structure 100 and discharge spout 12 as liner discharge structure 100 passes therethrough. Once expanded, base 108 may be coupled to first end 104 of liner passage 102, at a first end of discharge spout 12, and flange 114 may be mounted to second end 106 at a second end of discharge spout 12.

In some embodiments, methods of passing liner discharge structure 100 through portions of discharge spout 12 includes passing liner discharge structure 100 through liner body 22. In this embodiment liner body 22 is formed such that a portion of liner structure 20 is seated within discharge spout 12. Further, liner body 22 may be coupled to base 108 and flange 114. Liner body 22, in some embodiments, is between approximately 3-4.5 millimeters thick within discharge spout 12, in order to prevent damage from the abrasive features of discharge spout 12 while also causing substantially no reduction in flow. Once liner body 22 is situated within discharge spout 12, liner discharge structure 100 may be passed through liner body 22 from either end of discharge spout 12. For example, liner discharge structure 100 may pass first end 104 through a second end of discharge spout 12 and through liner body 22. In some embodiments liner discharge structure 100 can reduce its cross-sectional area (e.g., collapsing rib structure 110). Liner passage 102 then can be guided through liner body 22. When liner passage 102 reaches a desired location (e.g., first end 104 passing through a first end of discharge spout 12), the liner discharge structure 100 may expand and remain stationary within discharge spout 12.

Liner discharge structure 100 may have any desired dimension to accommodate various sizes of discharge spouts 12 and interconnected components. In discharge spouts 12 with larger outer diameter size, less clearance is available to move correspondingly sized liner passages 102 through discharge spouts 12 of the same cross-sectional area. Conversely, discharge spouts 12 of smaller outside diameter are more restrictive of product(s) flowing therethrough. In either situation, however, embodiments of liner discharge structure 100 with collapsable rib structure 110 remain flexible and capable of accommodating variously sized discharge spouts 12 and/or interconnected components.

Once liner discharge structure 100 is installed within discharge spout 12, pumping the contents of container 10 through liner discharge structure 100 creates a low-pressure area within liner discharge structure 100 and discharge spout 12. Conventionally, such a low-pressure area creates a risk of collapsing liner material(s) within discharge spout 12 and restricts or prevents discharge from container 10. However, liner discharge structure 100 including liner passage 102 and rib structure 110 prevent such a low-pressure region from collapsing liner material 112 within discharge spout 12. Furthermore, collapsable rib structure 110 may allow materials of larger cross-sectional area to be used, and thus withstand any vacuum created while discharging materials from container 10 through discharge spout 12.

Embodiments of the disclosure provide several technical and commercial advantages, some of which are discussed herein as examples. A liner discharge structure 100 according to the disclosure ensures that only chemically compatible materials are used in construction of liner passage 102, including its liner material 112 and flange 114. Embodiments of the disclosure provide a rib structure 110 for maintaining liner passage 102 width to increase flow of product therein. Moreover, embodiments of the disclosure provide an improved flow of product through discharge spout 12 through ensuring a wider diameter of liner discharge structure 100 within discharge spout 12. Various characteristics of liner discharge structure 100 according to the disclosure will prevent liner passage 102 from collapsing within discharge spout 12 when container 10 is emptied, such as rib structure 110. Embodiments of the disclosure are not limited for use with only a particular size and shape of tank and are operable for discharge spouts in a wide variety of shapes and sizes.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It is noted that the drawings of the disclosure are not necessarily to scale. The drawings are intended to depict only typical aspects of the disclosure, and therefore should not be considered as limiting the scope of the disclosure. In the drawings, similarly-colored or similarly-labeled elements represent like elements between the drawings.

What is claimed is:

1. A liner discharge structure adapted for insertion within a discharge spout of a container, the liner discharge structure comprising:
a liner passage including a liner material and enclosing a cross-sectional area substantially equal to a cross-sectional area of the discharge spout, the liner passage including a first end opposite a second end; and
a rib structure including a plurality of ribs extending at least partially along an extent of the liner passage between the first end and the second end.

2. The liner discharge structure of claim 1, wherein the rib structure is collapsible.

3. The liner discharge structure of claim 1, wherein the liner passage is flexible and wherein at least one rib in the plurality of ribs is rigid.

4. The liner discharge structure of claim 1, wherein the plurality of ribs includes a plurality of substantially uniformly spaced ribs.

5. The liner discharge structure of claim 1, wherein at least one rib in the plurality of ribs includes a substantially triangular cross-sectional profile.

6. The liner discharge structure of claim 1, wherein each rib in the plurality of ribs are connected by a connecting member extending at least partially along a longitudinal extent of the liner passage.

7. The liner discharge structure of claim 1, wherein a first rib in the plurality of ribs includes a first length greater than a second length of a second rib in the plurality of ribs.

8. The liner discharge structure of claim 6, wherein the liner passage includes a rigid portion laterally adjacent at least one end of the connecting member.

9. The liner discharge structure of claim 1, wherein a cross-sectional area of the flange is greater than a cross-sectional area of the discharge spout.

10. The liner discharge structure of claim 9, wherein the flange includes a substantially circular profile.

11. The liner discharge structure of claim 9, wherein a diameter of the flange is greater than a diameter of the discharge spout.

12. The liner discharge structure of claim 1, wherein the plurality of ribs extend at least partially along a longitudinal extent of the liner passage and intersect with each other.

13. A liner discharge structure adapted for insertion within a discharge spout of a container, the liner discharge structure comprising:
a liner passage including a liner material and enclosing a cross-sectional area substantially equal to a cross-sectional area of the discharge spout, the liner passage including a first end opposite a second end, wherein the liner material is flexible;
a rib structure including a plurality of ribs extending at least partially along an extent of the liner passage between the first end and the second end, wherein the rib structure is collapsable and wherein at least one rib in the plurality of ribs is rigid;
a base at the first end of the liner passage; and
a flange circumferentially coupled to the second end of the liner passage.

14. The liner discharge structure of claim 13, wherein at least one rib in the plurality of ribs includes a substantially triangular cross-sectional profile.

15. The liner discharge structure of claim 13, wherein the plurality of ribs includes substantially uniformly spaced ribs.

16. The liner discharge structure of claim 13, wherein a first rib in the plurality of ribs includes a first length greater than a second length of a second rib in the plurality of ribs.

17. A method to install a liner discharge structure within a discharge spout of a container, the method comprising:
passing a liner discharge structure through the discharge spout, wherein the liner discharge structure includes:
a liner passage having a liner material and enclosing a cross-sectional area substantially equal to a cross-sectional area of the discharge spout, the liner passage having a first end opposite a second end, and
a rib structure including a plurality of ribs extending at least partially along an extent of the liner passage between the first end and the second end;
mounting a base coupled to the first end of the liner passage on a first end of the discharge spout; and
mounting a flange coupled to the second end of the liner passage on the second end of the discharge spout.

18. The method of claim 17, further comprising:
circumferentially constricting a portion of the rib structure with a fastener during the passing of the liner discharge structure through the discharge spout; and
releasing the fastener from the rib structure after mounting the base and the flange on the discharge spout.

19. The method of claim 17, wherein the plurality of ribs includes substantially uniformly spaced ribs.

20. The method of claim 17, wherein a first rib in the plurality of ribs includes a first length greater than a second length of a second rib in the plurality of ribs.
